(19) United States
(12) Patent Application Publication
(10) Pub. No.: US 2026/0235182 A1
(43) Pub. Date: Aug. 13, 2026

(54) AIR SPRING FOR VEHICLE

(71) Applicant: ILJIN Co., LTD., Gyeongju-si Gyeongsangbuk-do (KR)

(72) Inventors: Sewoong JEONG, Ulsan (KR); Jonghyung SEO, Seoul (KR); Haseok OH, Gwangju (KR); Byunghwan KIM, Ulsan (KR); Sangwoo KIM, Gyeongsangnam-do (KR); Junghan KIM, Busan (KR)

(73) Assignee: ILJIN Co., LTD., Gyeongju-si Gyeongsangbuk-do (KR)

(21) Appl. No.: 19/536,436

(22) Filed: Feb. 11, 2026

(30) Foreign Application Priority Data
Feb. 12, 2025 (KR) 10-2025-0017787

(51) Int. Cl. F16F 9/04; F16F 9/05

(52) U.S. Cl. CPC F16F 9/0454; F16F 9/05; B60G 2206/424

(57) ABSTRACT

According to an example embodiment of the present disclosure, an air spring for a vehicle may include a sleeve, a top mount to which a bead formed on one end of the sleeve is coupled, a bead restraining member configured to constrain the bead of the sleeve in an axial direction, and a clamping ring positioned on the bead restraining member and configured to finally fix the bead of the sleeve and the bead restraining member to the top mount.

### CROSS-REFERENCE TO RELATED APPLICATION

This application claims priority to Korean Patent Application No. 10-2025-0017787 filed on Feb. 12, 2025, the entire content of which is herein incorporated by reference.

### TECHNICAL FIELD

The present disclosure relates to an air spring for a vehicle, and more particularly, to an air spring for a vehicle in which damage to a sleeve is minimized when the sleeve is fastened or while the air spring is operating.

### BACKGROUND

A suspension for a vehicle is provided between a vehicle body and a wheel to connect the vehicle body and the wheel as rigid bodies by one or multiple links. The suspension is supported by a spring, a shock absorber and the like in a vertical direction, and serves to appropriately balance a mechanical relative movement between the vehicle body and the wheel.

The suspension needs to satisfy the following basic conditions. That is, the suspension needs to effectively block shocks generated from an unevenness road surface when the vehicle is travelling, thereby providing a comfortable ride quality to passengers. The suspension needs to provide driving convenience by appropriately control the shaking of the vehicle body caused by a driving behavior of a driver and the unevenness road surface. Further, when the vehicle travels on the unevenness road surface, the suspension needs to support a vertical load acting on each tire at a contact surface with the unevenness road surface at an appropriate level, thereby ensuring the driving operation and stability of the vehicle during turning and braking.

In order to satisfy such conditions, various types of suspensions have been developed and applied to vehicles. In recent years, an air suspension has been widely applied to a deluxe vehicle.

An air spring, which is a constituent element of the air suspension, is arranged on an upper end of the shock absorber (so-called damper). For example, the damper may have a lower end portion connected to a side portion of a wheel of a lower control arm. In the air suspension, a top mount is a constituent element that connects the air spring and the damper to a vehicle body on an upper side of the air spring.

One end of a sleeve is fastened to the top mount. In general, a clamping ring is often used. For example, the sleeve may be fastened to the top mount by disposing the one end of the sleeve on a lower support surface of the top mount and clamping the clamping ring on the sleeve with a clamping tool.

However, in the related art, the clamping ring is directly fastened to the sleeve. As a result, an excessive force may be applied to the sleeve when fastening the clamping ring, which may primarily damage the sleeve. In addition, the sleeve exhibits a conical movement as a piston rod moves with the operation of the air spring. In such a fastening structure of the clamping ring in the related art, the sleeve may be additionally damaged due to load applied to the side of the sleeve when the sleeve exhibits the conical movement. The damage to the sleeve may cause air leakage.

### SUMMARY

The present disclosure was made to solve the above-mentioned matters, and the present disclosure is for the purpose of providing an air spring for a vehicle in which damage to a sleeve is minimized when the sleeve is fastened or while the air spring is operating.

An air spring for a vehicle according to an example embodiment of the present disclosure may include a sleeve 300, a top mount 100 to which a bead 320 formed at one end of the sleeve 300 is coupled, a bead restraining member 500 configured to restrain the bead 320 of the sleeve 300 in an axial direction, and a clamping ring 600 that is located on the bead restraining member 500 and finally fixes the bead 320 of the sleeve 300 and the bead restraining member 500 to the top mount 100.

In one aspect, the bead restraining member 500 may include an axial extension portion 520 and a radially-inward extension portion 540 extending inward from one end of the axial extension portion 520 in a radial direction, the radially-inward extension portion 540 configured to restrain the bead 320 in an axial direction.

In one aspect, the top mount 100 may include a first downward extension portion 120 extending downward from a lower surface of the top mount 100, and a second downward extension portion 140 arranged to be spaced apart from the first downward extension portion 120 in a radially outward direction and extending downward from the lower surface of the top mount. The bead 320 may be arranged between the first downward extension portion 120 and the second downward extension portion 140 to be restrained by the first downward extension portion 120 and the second downward extension portion 140 in the radial direction.

In one aspect, the bead 320 may include a reinforcing insert 322, and a portion of the reinforcing insert 322 may be configured to come into contact with the top mount 100 and the bead restraining member 500.

In one aspect, the clamping ring 600 may include an axial extension portion 620 and a radially-inward extension portion 640 extending inward from one end of the axial extension portion 620 of the clamping ring 600 in a radial direction. A radially-protruded portion or groove may be formed in an inner surface of the axial extension portion 620 of the clamping ring 600 such that the radially-protruded portion or groove is coupled with an outer surface of the axial extension portion 520 of the bead restraining member 500.

In one aspect, the bead restraining member 500 may include at least two or more members, which are assembled with each other to form a ring shape. The at least two or more members may not move relative to each other by the clamping ring 600 to maintain the ring shape in place.

In one aspect, an end portion surface 546 of the radially-inward extension portion 540 of the bead restraining member 500 may have a first end portion surface 544 formed to have an inner diameter that increases downward. The first end portion surface 544 may be formed in a gently convex curved shape in a sectional view.

In one aspect, the end portion surface 546 of the radially-inward extension portion 540 of the bead restraining member 500 may have a second end portion surface 542 formed to have an inner diameter that decreases downward. The second end portion surface 542 may be formed in a linear shape in the sectional view. The axial extension portion 520 of the bead restraining member 500 and the second downward extension portion 140 of the top mount 100 may be coupled to each other in a groove-protrusion structure.

In one aspect, a sealing ring 160 may be provided between a lower surface of the top mount 100 and the sleeve 300. As an example, the sleeve 300 may have a protruded portion 324 protruding in a radially inward direction. The sealing ring 160 may be installed in a space surrounded by an inner peripheral surface of the sleeve 300, the protruded portion 324 and the lower surface of the top mount 100.

In one aspect, the bead restraining member 500 may include a shock absorption groove 560 that opens in a radially outward direction and extends in a radially inward direction. As an example, the bead restraining member 500 may include a reinforcing rib 562 extending in the axial direction. The shock absorption groove 560 and the reinforcing rib 562 may be alternately arranged along a circumferential direction of the bead restraining member 500.

In one aspect, the radially-inward extension portion 540 may have a through-hole 564 formed to correspond to a cross-sectional shape of the radially-inward extension portion 540.

According to an example embodiment of the present disclosure, it is possible to minimize damage to a sleeve when the sleeve is fastened or while an air spring is operating, thus reducing a risk of air leakage.

### BRIEF DESCRIPTION OF THE DRAWINGS

FIG. 1 is a cross-sectional view of an air spring according to an example embodiment of the present disclosure.

FIG. 2 is a partial cross-sectional perspective view of a bead restraining member and surrounding components thereof according to an example embodiment of the present disclosure.

FIG. 3 is a partial cross-sectional view of the bead restraining member and surrounding components thereof according to an example embodiment of the present disclosure.

FIG. 4 is a perspective view of the bead restraining member according to an example embodiment of the present disclosure.

FIG. 5 is a perspective view of one member constituting the bead restraining member according to an example embodiment of the present disclosure.

### DETAILED DESCRIPTION

Various modifications may be added to example embodiments of the present disclosure. Specific example embodiments will be described with reference to the drawings. However, the present disclosure is not limited to the specific example embodiments but should be understood as including various modifications, equivalents or alterations, which fall within the scope and the technical sprit of the present disclosure. In descriptions of the drawings, like reference numerals will refer to the same or similar constituent elements. Further, although the terms such as a "first," a "second," "A," and the like used herein may be used to explain various constituent elements, such constituent elements should not be limited by such terms. The above terms may be used to distinguish a constituent element from another constituent element. For example, a first constituent element may be named as a second constituent element in another description of the specification without departing from the scope of the present disclosure. Conversely, the second constituent element may be named as the first constituent element in another description of the specification. The term "and/or" may be used to represent a combination of a plurality of related items described herein or at least one of the plurality of related items. Further, when a constituent element is referred to as being "coupled" or "connected" to another constituent element, the constituent element may be directly coupled or directly connected to the another constituent element, but yet another constituent element may be provided between the constituent element and the another constituent element. Further, when a constituent element is referred to as being "directly coupled" or "directly connected" to another constituent element, yet another constituent element may not be provided between the constituent element and the another constituent element. The terms used herein are merely used to describe specific example embodiments and do not limit the present disclosure. Expressions in the singular form should be understood to encompass expressions in the plural form unless the context clearly indicates otherwise. The term "includes," "has" or the like are intended to include features, numeric characters, operations, operations, constituent elements, parts, or a combination thereof, and should be understood not to exclude one or more other features, numeric characters, operations, operations, constituent elements, parts, or a combination thereof, or additional features and the like. Terms a "first," a "second," and the like are used to distinguish a plurality of constituent elements from each other, and the order or importance of corresponding constituent elements is not limited by these terms. Unless otherwise defined, all technical and scientific terms used herein have the same meaning commonly understood by those skilled in the art to which the present disclosure pertains. In addition, the commonly-used predefined terms should be interpreted as consistent with the meanings of the context in the related art and should not be interpreted as having ideal or excessive formal meanings unless otherwise defined in this application.

When one constituent element "comprise or includes" another constituent element through the specification and the claims, this means that the one constituent element may further include other constituent elements, rather than excluding other constituent elements, unless other stated. Hereinafter, preferred example embodiments of the present disclosure will be described in detail with reference to the accompanying drawings.

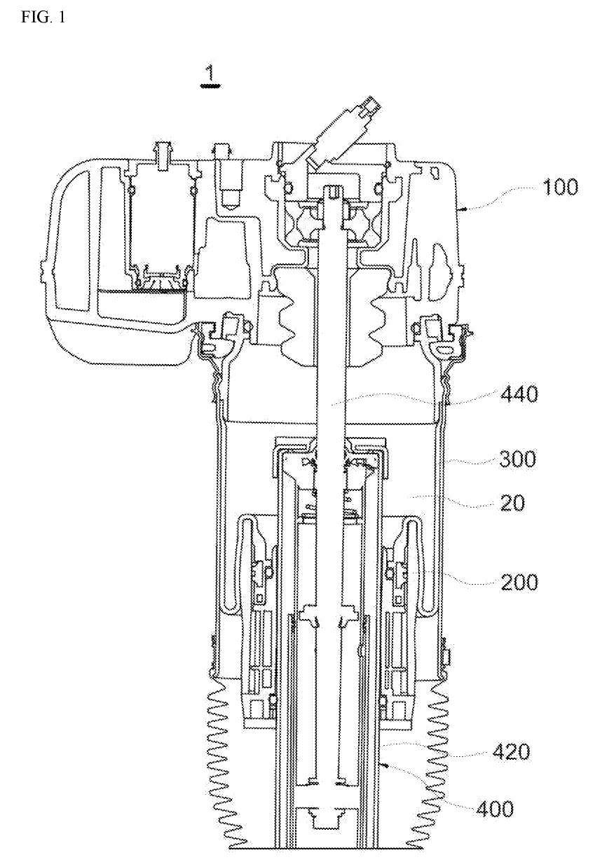

FIG. 1 is a cross-sectional view of an air spring according to an example embodiment of the present disclosure. Hereinafter, an overall structure and operation of the air spring according to an example embodiment of the present disclosure will be described with reference to FIG. 1.

As shown in FIG. 1, an air spring 1 may be configured to include at least a top mount 100, a piston 200, a sleeve 300 which is air-tightly connected to the top mount 100 and the piston 200, and a damper 400. As an example, one end of the sleeve 300 may be air-tightly fixed to a lower portion of the top mount 100, and the other end of the sleeve 300 may be airtightly fixed to the piston 200.

The top mount 100, the piston 200 and the sleeve 300 form an operation space 20 filled with compressed air.

The damper 400 may include a damper tube 420 and a piston rod 440. One end of the piston rod 440 is fixed to the top mount 100. The piston rod 440 is configured to pass through the damper tube 420. The damper tube 420 is configured to be movable relative to the piston rod 440 in an up-down direction.

According to an example embodiment of the present disclosure, the piston 200 is mounted on the damper 400 and is configured to move in an axial direction (in other words, the up-down direction) with the damper 400.

The piston 200 may be mounted directly to the damper tube 420. Alternatively, as shown in FIG. 1, the piston 200 may be mounted on the damper tube 420 via an intermediate structure (for example, an adapter).

When the piston 200 moves upward in the axial direction (the up-down direction) relative to the sleeve 300, a bent portion of the sleeve 300 may be rolled together with the piston 200 to have a rounded shape. This further compresses the compressed air in the operation space 20 formed by the top mount 100, the sleeve 300, and the piston 200. Accordingly, the air spring 1 performs a buffer function.

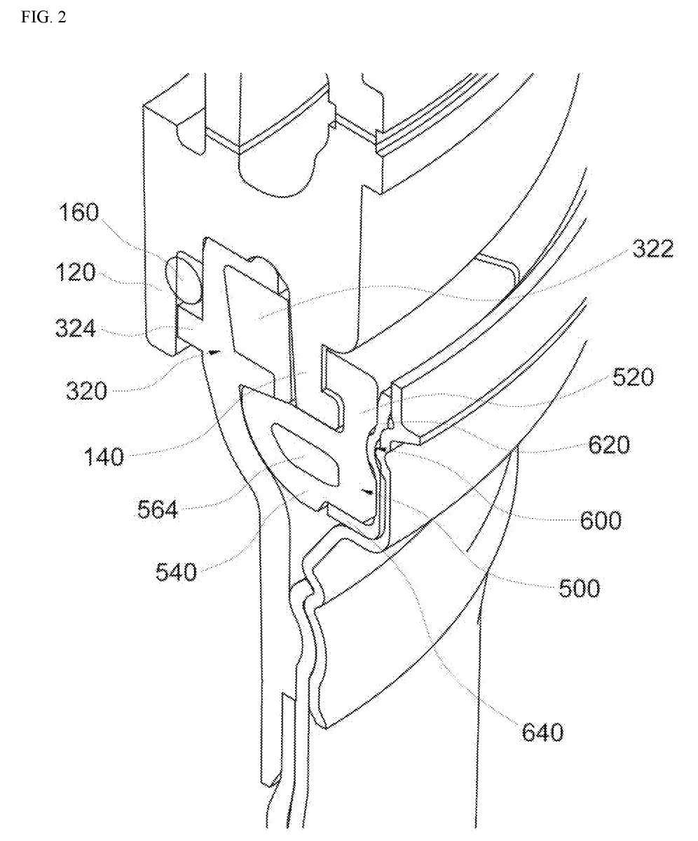

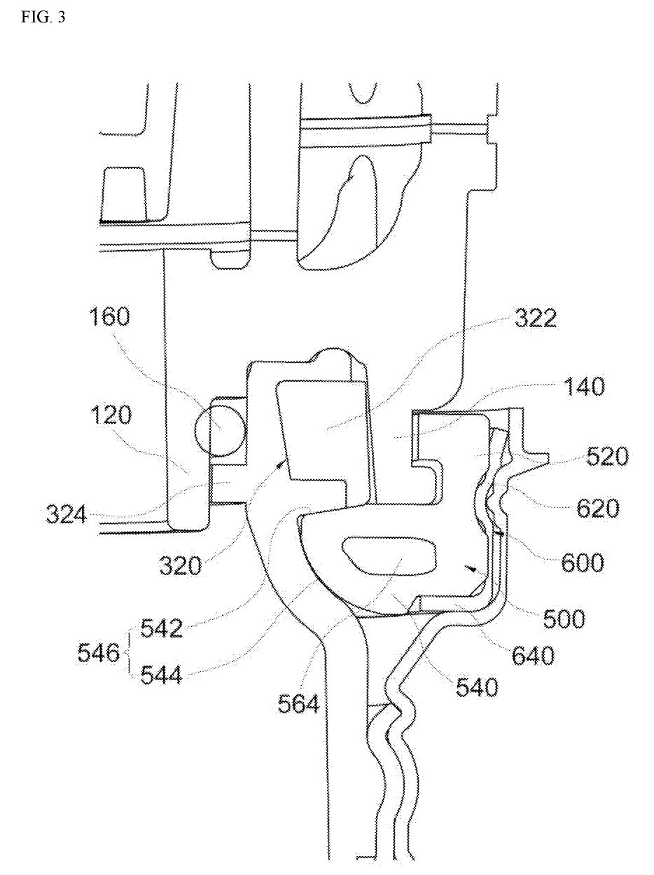

FIG. 2 is a partial cross-sectional perspective view of a bead restraining member and surrounding components thereof according to an example embodiment of the present disclosure. FIG. 3 is a partial cross-sectional view of the bead restraining member and the surrounding components thereof according to an example embodiment of the present disclosure.

Next, a structure in which the sleeve is air-tightly fastened to the top mount according to an example embodiment of the present disclosure will be described with reference to FIGS. 2 and 3.

As shown in FIGS. 2 and 3, a bead restraining member 500 according to an example embodiment of the present disclosure is a constituent element configured to restrain a bead 320 of the sleeve 300 in the axial direction. Further, the bead restraining member 500 restrains the bead 320 of the sleeve 300 in the radial direction in cooperation with a lower surface of the top mount 100.

One of features in which the bead restraining member 500 of the present disclosure is distinguished from a fastening means in the related art (for example, a clamping ring which is clamped directly to the sleeve) is that the bead restraining member 500 of the present disclosure constrains the bead 320 of the sleeve 300 in the axial direction and does not finally fasten the bead 320 of the sleeve 300 to the top mount 100.

For example, the bead restraining member 500 of the present disclosure itself cannot finally fasten the bead 320 of the sleeve 300 to the top mount 100. For this reason, a final fastening means such as a separate clamp ring is needed. This point will be described in more detail below.

According to an example embodiment of the present disclosure, the bead restraining member 500 includes an axial extension portion 520 and a radially-inward extension portion 540 extending from one end of the axial extension portion 520 in a radially inward direction. The radially-inward extension portion 540 restrains the bead 320 of the sleeve 300 in the axial direction.

To this end, according to an example embodiment of the present disclosure, the bead 320 of the sleeve 300 may be formed to have a structure that protrudes from one end of the sleeve 300 in the radially outward direction. Thus, the bead 320 protruding from the sleeve 300 in the radially outward direction is locked to the radially-inward extension portion 540 of the bead restraining member 500 in the axial direction. Thus, the bead 320 of the sleeve 300 is restrained by the bead restraining member 500 in the axial direction.

According to an example embodiment of the present disclosure, the top mount 100 may be configured to include a first downward extension portion 120 extending downward from the lower surface of the top mount 100, and a second downward extension portion 140 arranged to be spaced apart from the first downward extension portion 120 in the radially outward direction and extending downward from the lower surface of the top mount 100. In this configuration, the bead 320 of the sleeve 300 may be arranged between the first downward extension portion 120 and the second downward extension portion 140 and may be restrained by the first downward extension portion 120 and the second downward extension portion 140 in the radial direction.

Further, according to an example embodiment of the present disclosure, the bead 320 of the sleeve 300 may be configured to include a reinforcing insert 322 to more reliably ensure the confinement by the bead restraining member 500 in the axial direction. As an example, by forming the sleeve 300 in an over-molding manner with the reinforcing insert 322 inserted into a mold, the bead 320 of the sleeve 300 may be formed such that the reinforcing insert 322 is at least partially embedded in the bead 320. The reinforcing insert 322 is partially embedded in the bead 320 of the sleeve 300 so that the reinforcing insert 322 may be configured to come into contact with the second downward extension portion 140 of the top mount 100 and the bead restraining member 500.

Further, according to an example embodiment of the present disclosure, a sealing ring 160 in the form of an O-ring may be provided between the lower surface of the top mount 100 and the sleeve 300. Thus, the sleeve 300 may be air-tightly coupled to the top mount 100. As an example, the sleeve 300 includes a protruded portion 324 protruding in the radially inward direction. The sealing ring 160 may be installed in a space surrounded by an inner peripheral surface of the sleeve 300, the protruded portion 324 and the lower surface of the top mount 100.

According to an example embodiment of the present disclosure, the axial extension portion 520 of the bead restraining member 500 and the second downward extension portion 140 of the top mount 100 may be coupled to each other in a groove-protrusion structure. The coupling based on the groove-protrusion structure used herein does not mean finally fastening the bead restraining member to the top mount but means positioning the bead restraining member in place (before finally fastening with the clamp ring, which will be described below). Thus, the groove-protrusion structure does not mean a press-fitting structure.

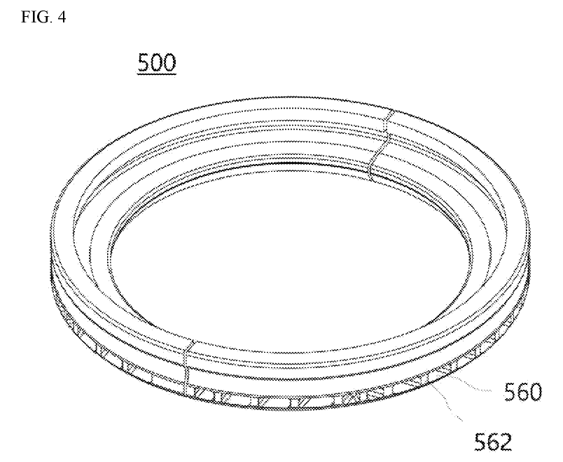

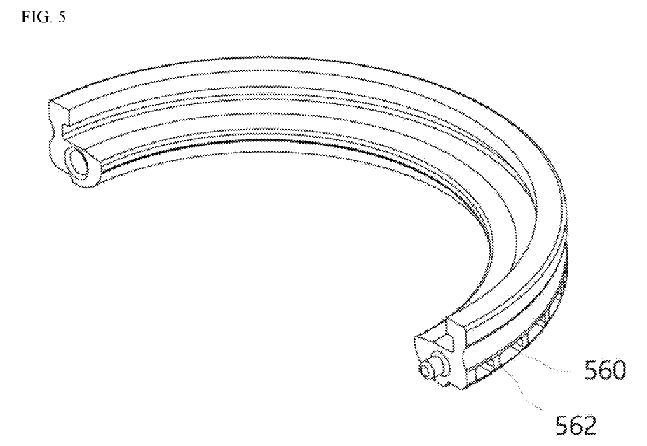

FIG. 4 is a perspective view of the bead restraining member according to an example embodiment of the present disclosure. FIG. 5 is a perspective view of one member constituting the bead restraining member according to an example embodiment of the present disclosure.

As shown in FIGS. 4 and 5, according to an example embodiment of the present disclosure, the bead restraining member 500 is constituted with at least two or more members and may have a ring-shaped structure in which the at least two or more members are assembled with each other.

According to an example embodiment of the present disclosure, in the state in which the bead 320 of the sleeve 300 has been restrained by the bead restraining member 500 in the axial direction or the radial direction, the bead 320 of the sleeve 300 may finally be fastened to the top mount 100 by the clamping ring 600.

The clamping ring 600 has an annular ring structure as a whole to surround and clamp at least partially the bead restraining member 500.

As an example, the clamping ring 600 may be configured to include an axial extension portion 620 and a radially-inward extension portion 640 extending from one end of the axial extension portion 620 in the radially inward direction. Preferably, a radially-protruded portion or groove is formed in an inner surface of the axial extension portion 620 of the clamping ring 600 such that the radially-protruded portion or groove may be coupled with an outer surface of the axial extension portion 520 of the bead restraining member 500.

The clamping ring 600 is clamped onto the bead restraining member 500 using, for example, a clamping tool, to finally fasten the bead 320 of the sleeve 300 to the top mount 100 via the bead restraining member 500 arranged inward of the clamping ring 600.

In the above-described structure, the clamping ring 600 is not directly clamped to the sleeve 300. This eliminates the risk of primarily damaging the sleeve 300 when fastening the clamping ring.

In general, as the piston rod 440 moves with the operation of the air spring, the sleeve 300 exhibits a conical movement. However, in a clamping-ring fastening structure in the related art, when the sleeve 300 exhibits such a conical movement, the sleeve 300 may be additionally damaged due to a load applied to a side of the sleeve 300.

According to an example embodiment of the present disclosure, the bead restraining member 500 is formed with only the radially-inward extension portion 540 and does not by itself finally fasten the bead 320 of the sleeve 300 to the top mount 100. Accordingly, the bead restraining member 500 is not pressed toward the bead 320 of the sleeve 300. This suppresses the excessive load from being applied to the sleeve 300 due to the bead restraining member 500 when the sleeve 300 exhibits the conical movement.

Further, according to an example embodiment of the present disclosure, an end portion surface 546 of the radially-inward extension portion 540 of the bead restraining member 500 has a first end portion surface 544 formed to have an inner diameter that increases downward. The first end portion surface 544 may be formed in a gently convex curved shape in a sectional view. By the shape of the first end portion surface 544 and the bead restraining member 500 when the sleeve 300 exhibits the upon conical movement, the excessive load is prevented from being applied to the side of the sleeve 300. Preferably, the end portion surface 546 of the radially-inward extension portion 540 of the bead restraining member 500 has a second end portion surface 542 formed to have an inner diameter that decreases downward. The second end portion surface 542 may be formed in a linear shape in a sectional view.

Further, according to an example embodiment of the present disclosure, the bead restraining member 500 may further include a shock absorption groove 560 to prevent the excessive load from being applied to the sleeve 300 when the sleeve 300 exhibits the conical movement.

As an example, the bead restraining member 500 may include one or more shock absorption grooves 560 which open in the radially outward direction and extend in the radially inward direction. The bead restraining member 500 may further include a reinforcing rib 562 extending in the axial direction. The shock absorption groove 560 and the reinforcing rib 562 may be alternately arranged along a circumferential direction of the bead restraining member 500.

Further, the radially-inward extension portion 540 of the bead restraining member 500 may be preferably configured to have a through-hole 564 corresponding to a cross-sectional shape of the radially-inward extension portion 540.

### EXPLANATION OF REFERENCE NUMERAL

1: Air spring

20: Operation space

100: Top mount

120: First downward extension portion

140: Second downward extension portion

160: Sealing ring

200: Piston

300: Sleeve

320: Bead

322: Reinforcing insert

324: Protruded portion

400: Damper

420: Damper tube

440: Piston rod

500: Bead restraining member

520: Axial extension portion

540: Radially-inward extension portion

542: Second end portion surface

544: First end portion surface

546: End portion surface

560: Shock absorption groove

562: Reinforcing rib

564: Through-hole

600: Clamping ring

620: Axial extension portion

640: Radially-inward extension portion

What is claimed is:

1. An air spring for a vehicle, comprising:
a sleeve (300);
a top mount (100) to which a bead (320) formed at one end of the sleeve (300) is coupled;
a bead restraining member (500) configured to axially restrain the bead (320) of the sleeve (300); and
a clamping ring (600) that is located on the bead restraining member (500) and finally fixes the bead (320) of the sleeve (300) and the bead restraining member (500) to the top mount (100).

2. The air spring of claim 1, wherein the bead restraining member (500) includes an axial extension portion (520) and a radially-inward extension portion (540) extending from one end of the axial extension portion (520) in a radially inward direction, the radially-inward extension portion (540) configured to restrain the bead (320) in an axial direction.

3. The air spring of claim 2, wherein the top mount (100) includes a first downward extension portion (120) extending downward from a lower surface of the top mount (100), and a second downward extension portion (140) arranged to be spaced apart from the first downward extension portion (120) in a radially outward direction and extending downward from the lower surface of the top mount, and
wherein the bead (320) is arranged between the first downward extension portion (120) and the second downward extension portion (140) to be restrained by the first downward extension portion (120) and the second downward extension portion (140) in the radial direction.

4. The air spring of claim 1, wherein the bead (320) includes a reinforcing insert (322), and
wherein a portion of the reinforcing insert (322) is configured to come into contact with the top mount (100) and the bead restraining member (500).

5. The air spring of claim 2, wherein the clamping ring (600) includes an axial extension portion (620) and a radially-inward extension portion (640) extending from one end of the axial extension portion 620 of the clamping ring (600) in the radially inward direction, and
wherein a radially-protruded portion or groove is formed in an inner surface of the axial extension portion (620) of the clamping ring (600) such that the radially-protruded portion or groove is coupled with an outer surface of the axial extension portion (520) of the bead restraining member (500).

6. The air spring of claim 1, wherein the bead restraining member (500) includes at least two or more members, which are assembled with each other to form a ring shape.

7. The air spring of claim 6, wherein the at least two or more members do not move relative to each other by the clamping ring (600) to maintain the ring shape in place.

8. The air spring of claim 2, wherein an end portion surface (546) of the radially-inward extension portion (540) of the bead restraining member (500) has a first end portion surface (544) formed to have an inner diameter that increases downward, and
wherein the first end portion surface (544) is formed in a gently convex curved shape in a sectional view.

9. The air spring of claim 8, wherein the end portion surface (546) of the radially-inward extension portion (540) of the bead restraining member (500) has a second end portion surface (542) formed to have an inner diameter that decreases downward, and
wherein the second end portion surface (542) is formed in a linear shape in the sectional view.

10. The air spring of claim 3, wherein the axial extension portion (520) of the bead restraining member (500) and the second downward extension portion (140) of the top mount (100) are coupled to each other in a groove-protrusion structure.

11. The air spring of claim 1, wherein a sealing ring (160) is provided between a lower surface of the top mount (100) and the sleeve (300).

12. The air spring of claim 11, wherein the sleeve (300) has a protruded portion (324) protruding in a radially inward direction, and
wherein the sealing ring (160) is installed in a space surrounded by an inner peripheral surface of the sleeve (300), the protruded portion (324) and the lower surface of the top mount (100).

13. The air spring of claim 1, wherein the bead restraining member (500) includes a shock absorption groove (560) that opens in a radially outward direction and extends in a radially inward direction.

14. The air spring of claim 13, wherein the bead restraining member (500) further includes a reinforcing rib (562) extending in the axial direction, and
wherein the shock absorption groove (560) and the reinforcing rib (562) are alternately arranged along a circumferential direction of the bead restraining member (500).

15. The air spring of claim 2, wherein the radially-inward extension portion (540) has a through-hole (564) formed to correspond to a cross-sectional shape of the radially-inward extension portion (540).
